(19) United States
(12) Patent Application Publication
(10) Pub. No.: US 2024/0134113 A1
(43) Pub. Date: Apr. 25, 2024

(54) CONTROLLING REFRACTIVE INDEX PROFILE DURING FIBER PREFORM MANUFACTURING

(71) Applicant: Lumentum Operations LLC, San Jose, CA (US)

(72) Inventors: Peter HOFMANN, Feuchtwangen (DE); Peter JAKOPIC, Videm-Dobrepolje (SI); Martin H. MUENDEL, Oakland, CA (US)

(21) Appl. No.: 18/191,683

(22) Filed: Mar. 27, 2023

Related U.S. Application Data
(60) Provisional application No. 63/380,207, filed on Oct. 19, 2022.

(51) Int. Cl. G02B 6/02; C03B 37/012; C03B 37/018; C03B 37/027

(52) U.S. Cl. CPC G02B 6/02338; C03B 37/01217; C03B 37/01815; C03B 37/02718; C03B 37/02736; G02B 6/02395

(57) ABSTRACT

In some implementations, a substrate tube in a modified chemical vapor deposition process may rotate while glass precursors flow into the substrate tube at a fixed rate. Dopants may be delivered into the substrate tube while heat is applied to the substrate tube to deposit, on an inner wall of the substrate tube, a layer of material including the glass precursors and the dopants. A lateral position of an exit of an injection tube used to deliver the dopants may be adjusted while the substrate tube is rotated and heat is applied to the substrate tube such that the material deposited on the inner wall of the substrate tube has an azimuthally non-uniform doping concentration. Alternatively, a rotation of the substrate tube may be adjusted to create opposing temperature gradients within the substrate tube, causing non-uniform layer deposition to occur on different sides of the substrate tube in alternating passes.

### CROSS-REFERENCE TO RELATED APPLICATION

This patent application claims priority to U.S. Provisional Patent Application No. 63/380,207, filed on Oct. 19, 2022, and entitled “APPARATUS TO CONTROL REFRACTIVE INDEX PROFILE DURING FIBER PREFORM MANUFACTURING.” The disclosure of the prior application is considered part of and is incorporated by reference into this patent application.

### TECHNICAL FIELD

The present disclosure relates generally to preform manufacturing and to techniques for manufacturing a fiber preform with a core that has a rotationally varying refractive index profile.

### BACKGROUND

A fiber preform is a typically cylindrical piece of optical glass that is used to draw an optical fiber in a fiber drawing tower. The drawn fiber has a much smaller diameter than the fiber preform, and all features of the fiber preform generally become correspondingly smaller in the drawn fiber. In particular, this holds for the refractive index profile, including the structure made for the fiber core. Many fiber preforms are fabricated using a process referred to as modified chemical vapor deposition (MCVD). In an MCVD process, a mixture of oxygen, silicon tetrachloride (SiCl₄), and possibly other substances (e.g. germanium tetrachloride (GeCl₄) and rare earth dopants) are delivered to the inside of a substrate tube made from synthetic fused silica, and while the substrate tube is heated from the outside using a hydrogen/oxygen burner or an induction furnace, chemical reactions in the gas stream (e.g., oxidation) produce a fine white “soot” of (often doped) silica that is then deposited on the inner wall of the substrate tube and subsequently vitrified into a clear glass layer. Alternatively, rather than using MCVD techniques, plasma-activated chemical vapor deposition (PCVD) can be used to fabricate a fiber preform, where the main difference between MCVD and PCVD is that microwaves are used to heat the deposition region, which results in a slow but very precise deposition. The general advantage of vapor deposition methods is that extremely low propagation losses can be achieved because materials with a very high purity can be used and contamination is avoided.

Conventional dopant precursors in MCVD exist in the liquid form (e.g., SiCl₄, GeCl₄, and/or phosphorus oxychloride (POCl₃), among other examples) with high enough vapor pressure to be delivered to the substrate tube using carrier gas (typically oxygen) that bubbles through the liquid. For some dopants, however (e.g., aluminum, active dopants such as erbium (Er), ytterbium (Yb), and/or cerium (Ce)), there are no liquid precursors with a high enough vapor pressure to be able to use traditional bubblers. One way to deliver these precursors to the deposition zone is to use organometallic chelates (e.g., organometallic chelates of Yb, Er, or the like) or other precursors (e.g., aluminum chloride (AlCl₃)) that have a sufficiently high vapor pressure at increased temperatures. In order to deliver these precursors to the reaction zone, heated lines are required. Heating is to be extended all the way to the heated section of the substrate tube, to prevent condensation. This is achieved using an injection tube containing one or more gas and/or vapor conduits that protrude into the substrate tube and can be mounted on a movable mechanism, allowing the tip of injection tube to be positioned at an arbitrary position with respect to the reaction zone. In some instances, the injection tube acts as an evaporation device, containing raw precursors (e.g., ytterbium chloride (YbCb) or erbium chloride (ErCb)), and the injection tube is heated from the outside using a hydrogen/oxygen burner or an induction furnace.

### SUMMARY

In some implementations, a method for controlling a refractive index profile for a fiber preform includes rotating a substrate tube while one or more glass precursors flow into the substrate tube at a fixed rate; delivering one or more dopants into the substrate tube while applying heat to the substrate tube to deposit, on an inner wall of the substrate tube, a layer of material that includes the one or more glass precursors and the one or more dopants; and adjusting a lateral position of an exit of an injection tube while the substrate tube is rotated and the heat is applied to the substrate tube, wherein adjusting the lateral position of the exit of the injection tube results in the layer of material deposited on the inner wall of the substrate tube having an azimuthally non-uniform doping concentration.

In some implementations, a method for controlling a refractive index profile for a fiber preform includes causing one or more glass precursors to flow into a substrate tube at a fixed rate; adjusting, in a first pass while a heat source moves in a backward direction along a longitudinal axis of the substrate tube, a rotation of the substrate tube to create a first temperature gradient from a first side of the substrate tube to a second side of the substrate tube; delivering, in the first pass, one or more dopants into the substrate tube with a first dopant concentration, wherein the first temperature gradient causes a first porous layer of material that includes the one or more glass precursors and the one or more dopants to be deposited on an inner wall of the substrate tube with a higher deposition volume on the first side of the substrate tube in the first pass; adjusting, in a second pass while the heat source moves in the backward direction along the longitudinal axis of the substrate tube, the rotation of the substrate tube to create a second temperature gradient from the second side of the substrate tube to the first side of the substrate tube; and delivering, in the second pass, one or more dopants into the substrate tube with a second dopant concentration, wherein the second temperature gradient causes a second porous layer of material that includes the one or more glass precursors and the one or more dopants to be deposited on the inner wall of the substrate tube with a higher deposition volume on the second side of the substrate tube in the second pass.

In some implementations, an optical fiber includes a core having a rotationally varying refractive index profile; and a cladding surrounding the core.

### BRIEF DESCRIPTION OF THE DRAWINGS

FIG. 1 illustrates an example of a preform manufacturing technique based on modified chemical vapor deposition (MCVD).

FIG. 2 illustrates an example implementation of a preform manufacturing system to control a refractive index profile during preform manufacturing.

FIGS. 3A-3E illustrate example implementations of controlling a refractive index profile during preform manufacturing by adjusting a lateral position of an injection tube.

FIG. 4 illustrates an example of thermophoresis associated with conventional MCVD.

FIGS. 5A-5C illustrate an example implementation of controlling a refractive index profile during preform manufacturing by adjusting a rotation of a substrate tube while dopants are delivered through an injection tube to create a non-uniform temperature gradient that causes non-uniform layer deposition.

FIG. 6 illustrates an example process related to controlling a refractive index profile during preform manufacturing by adjusting a lateral position of an injection tube.

FIG. 7 illustrates an example process related to controlling a refractive index profile during preform manufacturing by adjusting a rotation of a substrate tube while dopants are delivered through an injection tube to create a non-uniform temperature gradient that causes non-uniform layer deposition.

### DETAILED DESCRIPTION

The following detailed description of example implementations refers to the accompanying drawings. The same reference numbers in different drawings may identify the same or similar elements.

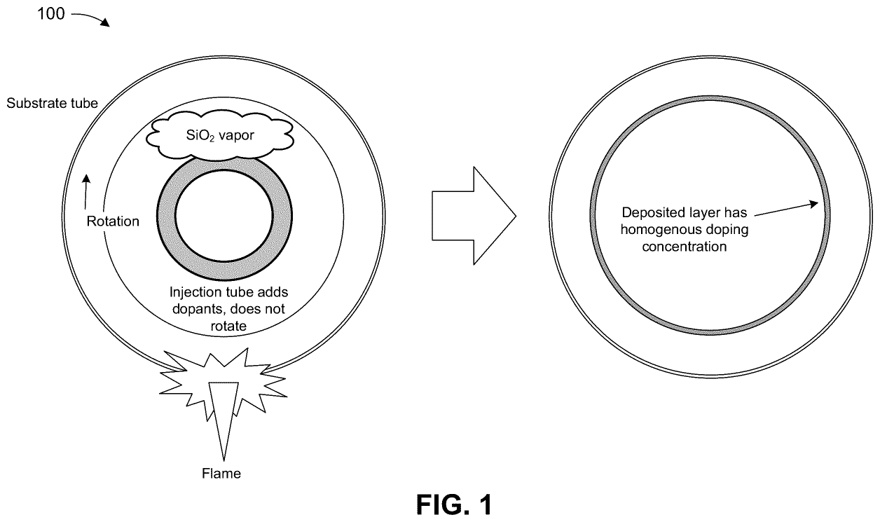

FIG. 1 illustrates an example 100 of a preform manufacturing technique based on modified chemical vapor deposition (MCVD). For example, as described herein, optical fibers and fiber preforms are often manufactured using MCVD techniques, plasma CVD (PCVD) techniques, and/or stack and draw techniques. For example, when MCVD techniques are used to manufacture high performance optical fibers and/or waveguides, glass precursors including select chemicals (e.g., silicon (Si), germanium (Ge), fluorine (F), phosphorus (P), or species thereof) are fused and deposited layer-by-layer onto an inner wall of a substrate tube after the glass precursors are subject to fire or another heat source. The glass precursors are generally mixed inside a substrate tube that rotates on a lathe, and the flame is controlled by a traveling burner or induction furnace that moves along the substrate tube and heats the substrate tube from the outside which causes a chemical reaction to take place inside the substrate tube, such that the material is fused and deposited on the inner wall of the substrate tube. After the deposition, the substrate tube is typically collapsed into a monolithic cylinder commonly referred to as a core preform. The core preform is then further reshaped before finally being drawn into an optical fiber. In PCVD techniques, thin films are deposited from a gas (vapor) state to a solid state on a substrate, with the plasma generally created by radio frequency, alternating current, or direct current discharge between two electrodes, the space between which is filled with the reacting gases.

For example, referring to FIG. 1, example 100 depicts a preform manufacturing technique based on MCVD, which may be used to deposit tens (10s) of layers on the inner wall of a substrate tube with a total thickness on an order of several 10s of microns for a step index fiber. Alternatively, PCVD techniques may be used to deposit thousands of layers, several microns thick, with very precise thickness and refractive index control. As shown in FIG. 1, the MCVD preform manufacturing technique may start with a substrate tube, which may be formed from silicon dioxide (SiO₂) or another suitable material. As further shown in FIG. 1, the substrate tube is rotated (e.g., on a lathe) and subjected to a flame (e.g., a torch) that passes along the substrate tube. In conventional MCVD techniques, gaseous precursors are connected to the substrate tube via a traditional rotary seal, sealing between a supply conduit and a rotating substrate tube. In another example, an injection tube (which is optionally heated) with one or more separate conduits is inserted into substrate tube through a modified rotary seal, allowing precursors to be delivered near the reaction zone unmixed and/or at an elevated temperature. The injection tube may rotate with the substrate tube or may remain stationary, but is allowed to move axially, in some cases in synchronization with the traversing heat source, and in other cases only manually to a desired position before the process taking place. As the substrate tube is rotated and subjected to the flame, doped SiO₂ vapor may form in the reaction zone and then condense on the inner surface of the substrate tube, such that a layer of material deposited on the inner wall of the substrate tube has a homogeneous doping concentration.

Accordingly, in a typical MCVD process used to manufacture an active core preform, an outer substrate tube (e.g., a fused SiO₂ tube) is mounted on an MCVD lathe, and the substrate tube is rotated while the flame passes along a deposition region of the substrate tube. The flame is used to heat up the precursors that are delivered through the substrate tube, where the precursors may include one or more carrier gases, such as oxygen (O₂) to promote reaction and/or helium (He) to modify thermal diffusivity of the mixture and/or control a length of a deposition zone, one or more glass precursor vapors, such as silicon tetrachloride (SiCl₄), and one or more dopant precursors, such as germanium tetrachloride (GeCl₄), phosphorus oxychloride (POCl₃), and/or fluorine species, among other examples. Furthermore, the injection tube arranged in the center of the substrate tube is used to centrally inject other precursors, such as chelate precursors for active ions (e.g., ytterbium, erbium, and/or aluminum as a co-dopant). Accordingly, in the MCVD process shown in FIG. 1, the central injection tube is used to inject one or more dopants, and a glass precursor (e.g., SiCl₄) is delivered into a surrounding intermediate space (e.g., an annulus) between the rotating substrate tube and the injection tube (which may be rotating or stationary).

At the exit of the injection tube, a dopant flow from injection mixes with a glass precursor flow, and the mixture enters the reaction zone, where the reaction generates particles along with effluent gas (e.g., chloring (Cl₂) or carbon dioxide (CO₂), among other examples). Particles exiting the reaction zone experience a temperature gradient (e.g., a higher temperature in the center and a lower temperature near the walls of a yet unheated tube), which causes the particles to move laterally and deposit on the inner wall of the substrate tube due to thermophoresis (e.g., where different particles in a mixture of mobile particles exhibit different responses to the force of a temperature gradient). Deposition then takes place as long as there is a lateral temperature gradient. Since flow is laminar, particles that were generated near the center of the substrate tube are not deposited before the temperature gradient wears off, and such particles are guided into the exhaust tube where they are collected by the exhaust system. Furthermore, particles that were generated closer to the wall on one side of the tube are deposited on the same side of the injection tube, optionally phase-shifted for some unknown, but constant angle due to rotation of the substate tube. Particles are formed from precursor gases, and the uniform central position of the injection tube causes an azimuthally symmetric dopant concentration, causing uniformly doped particles. Furthermore, because the flame is moving along the substrate tube, the flame travels into the area where the deposited layer is formed and heats the deposited layer to vitrify the glass.

As described herein, the MCVD technique shown in FIG. 1 is subject to a limitation, in that the layer of material deposited on the inner wall of the substrate tube has an azimuthally symmetric (e.g., homogeneous) doping concentration, which means that the refractive index profile of a fiber core formed from the preform is azimuthally symmetric throughout a cross-section of the core. However, in some cases, manufacturing an optical fiber that includes a core with a non-uniform refractive index profile may be desirable. For example, a slanted refractive index profile may be useful because a slant in one direction can compensate an effect resulting from bending of the fiber by increasing the effective area of the fiber, which allows for a larger mode field area that may reduce nonlinear effect in given conditions and thereby increase the amount of power that can be output from a laser with the same beam quality for a single mode profile. However, existing techniques to create a non-uniform refractive index profile are generally limited to varying a cladding region surrounding a homogenous core (e.g., by stacking different materials to create inhomogeneity).

Some implementations described herein relate to systems and methods to fabricate an optical fiber preform that includes a monolithic core with a non-uniform refractive index profile. For example, in some implementations, the systems and methods described herein may be used to create a preform structure with a refractive index profile that may vary in azimuthal and/or longitudinal directions. For example, the systems and methods described herein may allow for azimuthally, radially, and axially controlled variations of a core doping concentration when using an MCVD or PCVD lathe system to tailor the refractive index profile of optical fiber preforms. In this way, by controlling the refractive index profile of a fiber preform, an optical fiber may be fabricated with a rotationally varying refractive index distribution in the core. This may be achieved by adjusting or modulating a lateral position of the injection tube that is used to deliver dopants and synchronizing the lateral position of the injection tube with the substrate tube rotation. Particles that are generated on a first side of the substrate tube are thus more heavily doped than particles on a second (opposite) side of the substrate tube, as the particles on the first side of the substrate tube receive a larger flow of dopants from the injection tube, thereby forming a core on the inner face of the substrate tube by MCVD or PCVD with an azimuthally non-uniform doping concentration to modify the refractive index of the deposited layers. Additionally, or alternatively, rotation of the substrate tube may be adjusted while dopants are delivered via the injection tube and a heating source (e.g., a burner) creates a temperature gradient from one side of the substrate tube to the other, which causes a non-uniform layer deposition that imparts the azimuthally non-uniform doping concentration. In this way, some implementations described herein may induce a controlled rotationally varying modification of the core refractive index when fabricating an optical fiber preform using MCVD, PCVD, and/or other vapor deposition techniques.

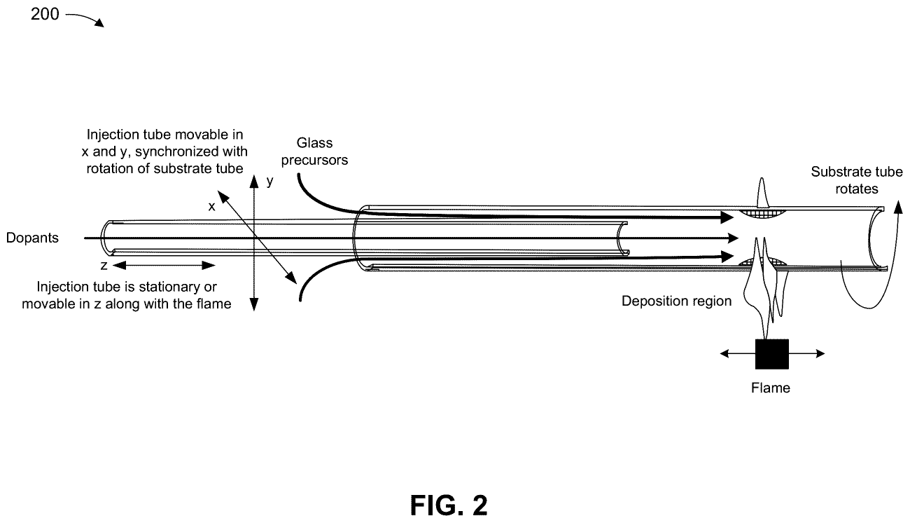

FIG. 2 illustrates an example implementation 200 of a preform manufacturing system that may control a refractive index profile during preform manufacturing. As shown in FIG. 2, the preform manufacturing system includes a substrate tube that is rotated while the substrate tube is subjected to a flame and an injection tube that may be disposed within the rotating substrate tube. In some implementations, as described herein, the substrate tube may be rotated while one or more glass precursors (e.g., species of Si, Ge, F, P, and/or other elements, such as SiCl₄, SiF₄, GeCl₄, POCl₃, or the like) flow into a space between the substrate tube and the injection tube at a fixed rate. Furthermore, while the substrate tube is rotated and heated by the flame, one or more dopants (e.g., rare earth dopant precursors such as Yb(tmhd)3, Er(tmhd)3, aluminum precursors such as AlCl₃, Al(acac)3, or in some instances also precursors other times flowing into a space between the substrate tube and the injection tube) may be delivered through the injection tube and into the region between the tip of the injection tube and the reaction zone. Accordingly, the heating of the substrate tube may cause chemical reactions to occur among the glass precursors delivered through the substrate tube and the injection tube, which may result in a doped layer of material being deposited on an inner wall of the substrate tube (e.g., within the deposition region shown in FIG. 2). Furthermore, as described herein, one or more techniques may be used to ensure that the layer of material deposited on the inner wall of the substrate tube has an azimuthally non-uniform (e.g., rotationally varying) doping concentration such that a preform fabricated from the layer of material has a monolithic core with a non-uniform refractive index profile.

For example, in some implementations, the non-uniform doping concentration may be achieved by adjusting (e.g., modulating or otherwise controlling) a lateral position of an exit of the injection tube while the substrate tube is rotated and heated by the flame. In particular, the lateral position of the exit of the injection tube may be adjusted in a manner that is synchronized with the rotation of the substrate tube and/or the movement of the flame. For example, as shown in FIG. 2, the injection tube may be movable in a z-axis direction along with the flame, and the injection tube may also be movable in an x-axis and a y-axis direction in a manner that is synchronized with the rotation of the substrate tube. For instance, as the glass precursors exiting the injection tube are entering the substrate tube more towards one side of the substrate tube, more dopants are deposited on that side of the substrate tube than the opposing side of the substrate tube. For example, by pinning tip movement to the one side of the substrate tube and decreasing an amplitude of the oscillation of the injection tube from a first pass to a last pass, a slanted doping concentration may be created. Furthermore, in some implementations, an amplitude and/or a phase of the lateral movement of the tip of the injection tube can be modified along a longitudinal axis of the substrate tube (e.g., in the z-axis direction) to compensate any longitudinal non-uniformity of the preform and/or to intentionally create longitudinal non-uniformity.

In this way, the lateral position of the exit of the injection tube may be moved up, down, left, and/or right (e.g., in the x-axis and/or y-axis directions) while the substrate tube rotates and the while the flame moves, which may cause a variation in the amount of dopants that are deposited at different circumferential or azimuthal positions on the inner wall of the substrate tube. For example, when the heat from the heat source causes chemical reactions to occur from the glass precursors delivered through the substrate tube and the dopant precursors delivered through the injection tube, there may be some particles that were created near the side of the substrate tube and some particles that were created closer to the center of the substrate tube. The particles created near the side of the substrate tube are deposited on the inner wall of the substrate tube, and the particles that were created closer to the center of the substrate tube pass the deposition zone and enter an exhaust. Accordingly, by adjusting or otherwise controlling the lateral position of the exit of the injection tube (e.g., the three-dimensional position where dopants enter the substrate tube) synchronously with the rotation of the substrate tube and the movement of the flame, the amount or volume of dopants that are actually deposited on the inner wall of the substrate tube can be precisely controlled. For example, the precise lateral position of the injection tube in x-axis, y-axis, and z-axis directions may be coupled with the frequency at which the substrate tube rotates to ensure that more dopants are always deposited on one side of the substrate tube. As a result, the substrate tube may have one side that is doped more heavily and one side that is doped more lightly (e.g., the doping concentration is not homogeneous around the inner wall of the substrate tube), which creates an uneven or non-uniform refractive index profile across a cross-section of the deposited layer of material.

Additionally, or alternatively, in some implementations, the non-uniform doping concentration may be achieved by adjusting (e.g., modulating or otherwise controlling) a rotation of the substrate tube based on the movement of the heat source to create a temperature gradient from one side of the substrate tube to another. For example, in a first pass that occurs while the heat source is moving backward and heating the substrate tube to a temperature that is below a point at which glass softens, rotation of the substrate tube may be suspended or stopped, or the substrate tube may be rotated at a quasi-sinusoidal speed, to create a temperature gradient from a first side of the substrate tube to a second (opposite) side of the substrate tube while dopants are delivered into the substrate tube with a first dopant concentration. Accordingly, the temperature gradient causes a non-uniform porous layer of doped material to be deposited on the inner wall of the substrate tube, and the porous layer of doped material may be vitrified when the heat source subsequently moves in a forward direction along the longitudinal axis of the substrate tube (while the substrate tube rotates at a constant speed). Furthermore, in a second pass that occurs while the heat source is moving backward and heating the substrate tube, the substrate tube may be rotated 180 degrees relative to orientation of the substrate tube in the first pass, or the substrate tube may be rotated at a quasi-sinusoidal speed that is phase shifted 180 degrees relative to the first pass, to create a temperature gradient from the second side of the substrate tube to the first side of the substrate tube dopants are delivered into the substrate tube with a second dopant concentration. Accordingly, the temperature gradient causes a non-uniform porous layer of doped material to be deposited on the inner wall of the substrate tube, and the porous layer of doped material may be vitrified when the heat source subsequently moves in a forward direction along the longitudinal axis of the substrate tube (while the substrate tube rotates at a constant speed). The first pass and the second pass may be repeated multiple times to generate alternating deposition layers, where the difference between the first dopant concentration and the second dopant concentration decreases in each iteration to create a smooth gradient towards the center of the substrate tube. The substrate tube may then be collapsed or otherwise reshaped, causing the layers to partially diffuse into each other and create a smooth concentration gradient that confers a non-uniform refractive index profile.

In this way, as described herein, one or more techniques may be used to deposit a layer of doped material, including a combination of glass precursors and dopants, on the inner wall of the substrate tube with an azimuthally non-uniform doping concentration. For example, as described herein, the non-uniform doping concentration may be achieved by adjusting the lateral position of the exit of the injection tube and/or by creating a temperature gradient that causes non-uniform layer deposition via thermophoresis. In this way, the layer of doped material that is deposited on the inner wall of the substrate tube may be formed into a monolithic core that has a non-uniform refractive index profile (e.g., due to layer of material formed into the monolithic core having the azimuthally non-uniform doping concentration).

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

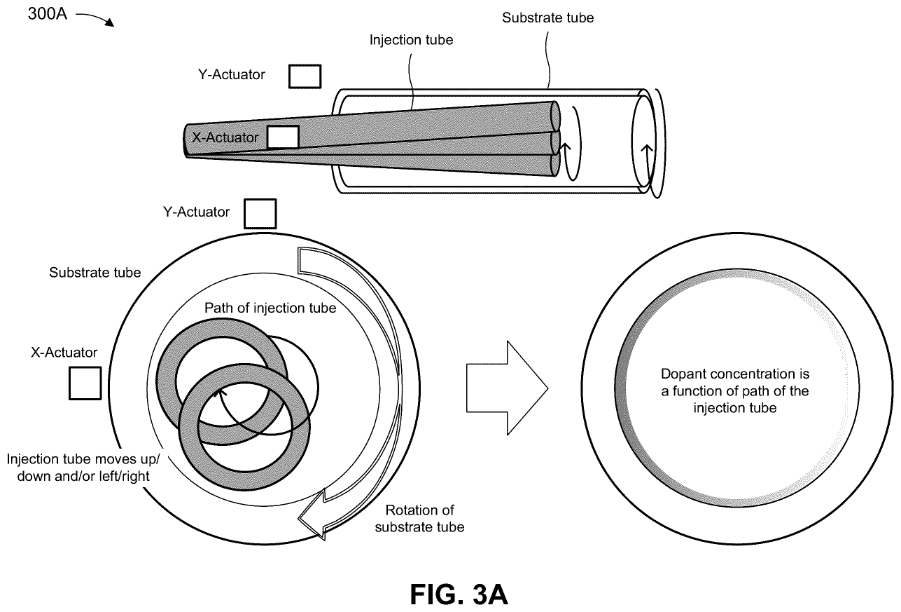

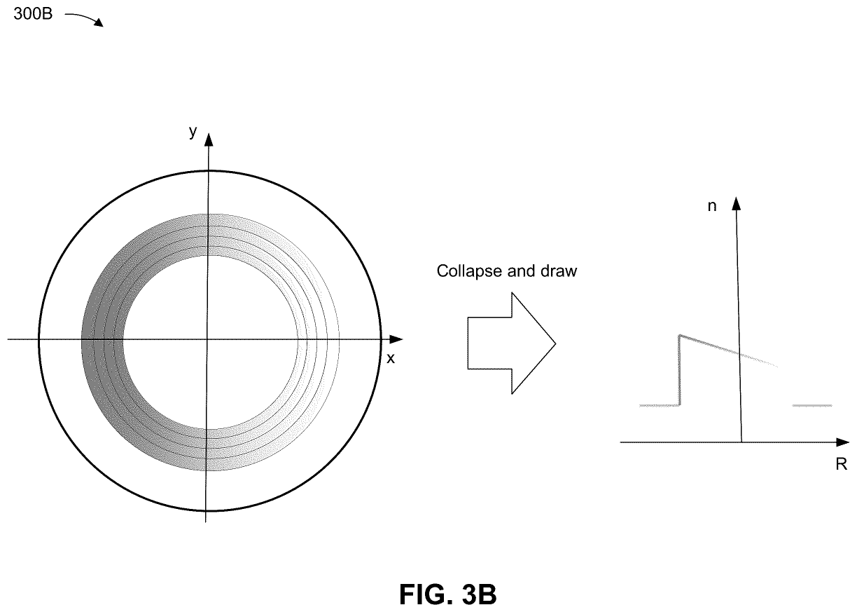

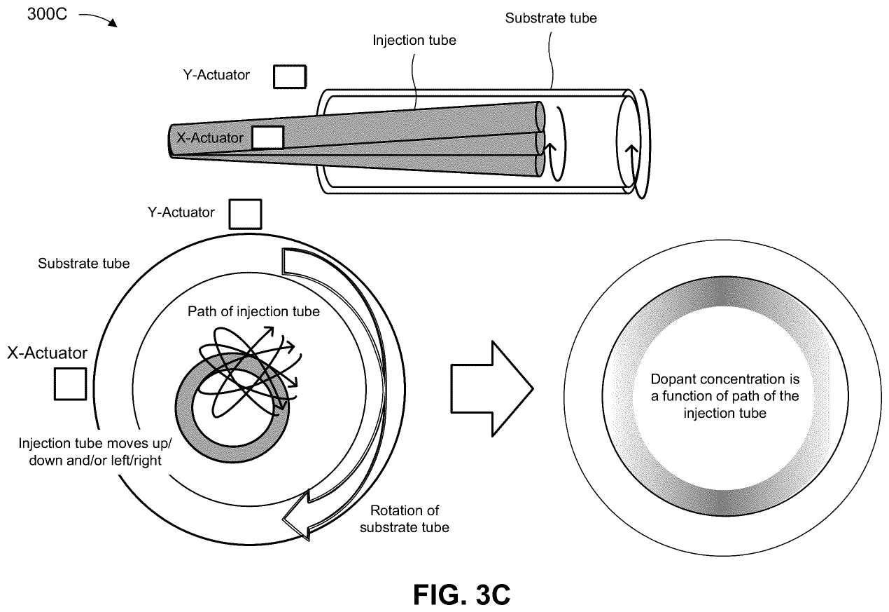

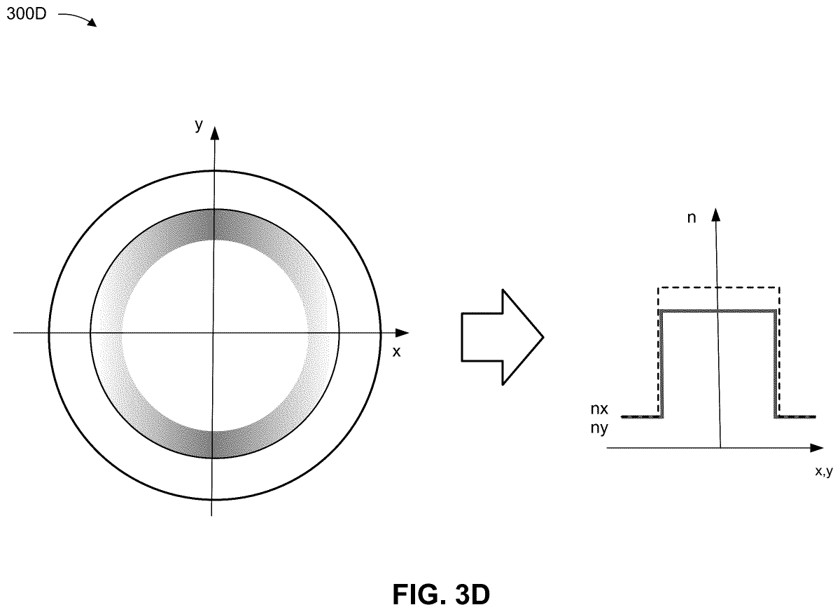

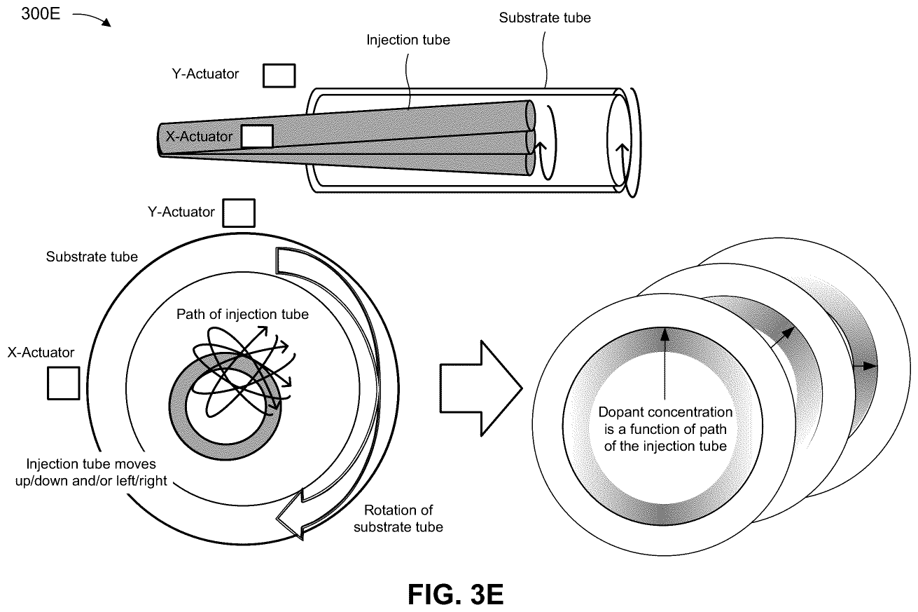

FIGS. 3A-3E illustrate example implementations 300A-300E of controlling a refractive index profile during preform manufacturing by adjusting a lateral position of an injection tube. However, it will be appreciated the fiber preform structures shown in FIGS. 3A-3E may also be fabricated using techniques of adjusting the rotation of the substrate tube to create a temperature gradient that results in azimuthally non-uniform deposition of layers of doped material.

As shown in FIG. 3A, and by example 300A, a fiber preform with a slanted refractive index profile may be fabricated by manipulating the lateral position of the exit of the injection tube in a manner that is synchronized with the rotation of the substrate tube. For example, as shown, a preform manufacturing system may include an x-actuator that can move the exit of the injection tube to the left or the right within the space inside the substrate tube, and the preform manufacturing system may also include a y-actuator that can move the exit of the injection tube up or down within the space inside the substrate tube. Accordingly, to create a fiber preform with a slanted refractive index profile, the lateral position of the injection tube and/or the temperature gradient within the substrate tube may be manipulated to ensure that the layer of material deposited on the inner wall of the substrate tube has a maximum value at a first circumferential or azimuthal position (e.g., 0 degrees) that monotonically decreases to a minimum value at a second circumferential or azimuthal position (e.g., 180 degrees). In this way, the concentration of dopants on the inner wall of the substrate tube is a function of a path that the injection tube follows while the substrate tube is rotating and/or the temperature gradient within the substrate tube while dopants are delivered through the injection tube. Accordingly, the substrate tube and the layer of material deposited on the inner wall of the substrate tube can then be reshaped to form a preform structure and drawn to form a fiber core with a non-uniform refractive index profile (e.g., a slanted refractive index profile in the case of the structure shown by example 300A in FIG. 3A).

For example, referring to FIG. 3B, example 300B illustrates a cross-sectional profile of the layer of material deposited on the inner wall of the substrate tube, where R refers to a position in a radial direction and n (shown on the y-axis) refers to a refractive index. Furthermore, in some implementations, an amplitude at which the injection tube oscillates decreases toward a last pass in order to achieve a smooth slant for the refractive index (e.g., versus a more step-like variation). In particular, the circular cross-section on the left shows the substrate tube with the layer of material deposited on the inner wall with a non-uniform doping concentration, which may then be collapsed into a solid rod that becomes the core structure in a fiber preform, and the core of the fiber preform has the slanted refractive index profile shown in the plot on the right side of FIG. 3B. Accordingly, in some implementations, the void inside the middle of the layer of deposited material may be eliminated by collapsing the tube with the deposited layer into a final solid rod that forms the fiber core with the refractive index profile shown in FIG. 3B. The fiber core may then be drawn and one or more cladding layers may be formed to surround the core to form the fiber preform. Additionally, or alternatively, other suitable techniques may be used to reshape the fiber preform. For example, in some implementations, the fiber preform can be jacketed before being drawn (e.g., an additional glass tube may be added around the core to modify a cladding-core diameter ratio (CCDR), and the additional glass tube can be fused together into a jacketed preform or an assembly of a core preform and a surrounding tube can be drawn simultaneously with a vacuum in between to create a final fiber). Additionally, or alternatively, the preform can be stretched to a smaller diameter prior to being inserted into a jacketing tube, or the preform with the core having the non-uniform refractive index profile can have part or all of an SiO₂ cladding layer removed by etching or mechanical grinding prior being stretched, jacketed, and/or drawn. Additionally, or alternatively, one or more instances of the preform can be inserted into a multi-core fiber. Accordingly, in some implementations, one or more processes may be performed on the preform prior to making a final fiber, where the processes may include grinding, stretching, jacketing, drilling, etching, stacking, drawing, and/or any suitable combination thereof.

In another potential application, as shown by example 300C in FIG. 3C, the lateral position of the exit of the injection tube and/or the flow of dopants through the injection tube may be manipulated to create a non-uniform refractive index profile with two or more azimuthal minima and maxima at opposing circumferential or azimuthal positions of the fiber core. In this way, the path of the injection tube and/or the temperature gradient within the substrate tube may be used to create a deposited layer with varying concentrations at different circumferential or azimuthal positions, which may confer certain birefringent and/or polarization-maintaining properties. Accordingly, the substrate tube and the layer of material deposited on the inner wall of the substrate tube can then be reshaped to form a preform structure and drawn to form a fiber core with a non-uniform refractive index profile (e.g., a refractive index profile with two or more azimuthal minima and maxima at opposing circumferential or azimuthal positions of the fiber core in the case of the structure shown by example 300C in FIG. 3C). For example, example 300D in FIG. 3D illustrates a cross-sectional profile of the layer of material deposited on the inner wall of the substrate tube and the refractive index profile of the monolithic core structure that may be formed when the layer of material is collapsed or otherwise reshaped, where nx refers to an index in an x-direction and ny refers to an index in a y-direction.

In another potential application, as shown by example 300E in FIG. 3E, the lateral position of the exit of the injection tube and/or the temperature gradient within the substrate tube may be manipulated to create a spiral refractive index profile having one or more maxima that rotationally vary along a length of the fiber core. In this way, the path of the injection tube and/or the flow of dopants through the injection tube may be adjusted to control the circumferential distribution of dopants in an arbitrary manner. For example, because the preform manufacturing system can modulate where the burner or flame traverses the substrate tube, the phase and amplitude of the oscillations in the movement of the injection tube and/or the flow of the dopants through the injection tube can be fine-tuned to create any arbitrary distribution of dopants in the circumferential or azimuthal direction. These arbitrary distributions may also vary along the length of the substrate tube to create spiral (or more complex) configurations. For example, the dopant distribution may be slanted, as described above with respect to FIGS. 3A-3B, or different maxima and minima can be created along the circumference of the substrate tube by modulating the dopant flow and/or position of the injection tube as the substrate tube rotates and the flame moves.

Accordingly, as described herein, one or more techniques may be used to create the non-uniform doping concentration for the layer of material deposited on the inner wall of the substrate tube, resulting in a monolithic core with a non-uniform refractive index profile after the layer of material is collapsed, drawn, reshaped, or otherwise processed. For example, a slanted refractive index profile may advantageously compensate the effect of bending the fiber. For example, the refractive index profile of a bent fiber is typically modeled as a refractive index of a fiber that is then slanted across the length. Accordingly, by creating a monolithic core with a refractive index profile that is pre-slanted in another direction, the slanted refractive index profile can compensate for the bending. This can have significant implications, because detrimental effects that bending have on the effective area can essentially be eliminated, which may decrease the nonlinear effects in single mode lasers. In other words, a non-uniform (e.g., slanted) refractive index profile may increase an effective area of the fiber, which results in a larger mode field area with reduced nonlinear effects in given conditions and/or increases the amount of power that can be provided by a laser with the same beam quality as a single mode profile.

As indicated above, FIGS. 3A-3E are provided as examples. Other examples may differ from what is described with regard to FIGS. 3A-3E. The number and arrangement of devices shown in FIGS. 3A-3E are provided as examples. In practice, there may be additional devices, fewer devices, different devices, or differently arranged devices than those shown in FIGS. 3A-3E. Furthermore, two or more devices shown in FIGS. 3A-3E may be implemented within a single device, or a single device shown in FIGS. 3A-3E may be implemented as multiple, distributed devices. Additionally, or alternatively, a set of devices (e.g., one or more devices) shown in FIGS. 3A-3E may perform one or more functions described as being performed by another set of devices shown in FIGS. 3A-3E.

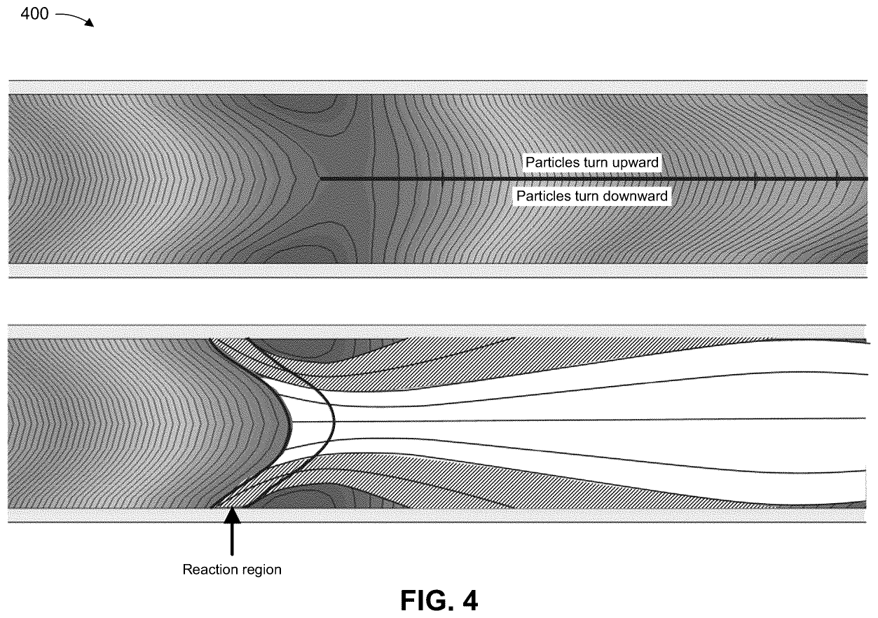

FIG. 4 illustrates an example 400 of thermophoresis associated with conventional MCVD. For example, as described herein, conventional or standard MCVD techniques typically form particles by the oxidation of reactant gases (e.g., glass precursors, dopants, and/or other materials), where the particles are then deposited and consolidated to form a high-quality glass film on the inner wall of a substrate tube. In general, particle deposition in the MCVD process may occur through thermophoresis, which is a phenomenon whereby particles suspended in a gas acquire a velocity in a direction of decreasing temperature.

For example, in conventional or standard MCVD processes, reactant gases flow through a rotating substrate tube (e.g., a fused silica tube), which is heated by an external heating source such as a burner or torch. The heating source slowly traverses the substrate tube in the same direction as the interior gas flow. As the cool reactant gases (e.g., SiCl₄, O₂, and various dopants) approach a hot zone of the traversing torch, shown in FIG. 4 as a reaction zone, the reactant gases are heated to reaction temperatures, which results in the formation of various particles. Furthermore, some heterogeneous reaction may occur on the walls of the substrate tube. The hot gas and suspended particles then flow through the section of the substrate tube downstream from the (hot) reaction zone, where the inner wall of the substrate tube is at a lower temperature than the gas. Here, a portion of the particles deposit thermophoretically in one or more deposition zones (e.g., shown in FIG. 4 using a cross-hatched pattern) due to the radial temperature gradients. Further downstream, gas and wall temperatures reach an equilibrium, deposition ceases, and the remaining particles (e.g., in the central portion of the substrate tube, shown with a white fill pattern in FIG. 4) are carried out the exhaust. As the heating source traverses the substrate tube, the particulate deposited on the inner wall of the substrate tube is consolidated into a thin vitreous pore-free layer by a viscous sintering mechanism. When the heating source reaches the end of a traversal of the substrate tube, the heating source quickly returns to the entrance end of the substrate tube and the process is repeated one or more times. In this way, a graded index profile can be achieved by varying the dopant concentration in each pass. After a sufficient number of layers are deposited (e.g., 30 to 50 layers), the substrate tube is collapsed into a solid rod, which is subsequently drawn into a thin optical fiber using a high temperature furnace or other suitable mechanism. Accordingly, in the conventional or standard MCVD techniques, the heating source is moving forward, which causes the porous layer of material deposited on the inner wall of the substrate tube to be vitrified in the same passing.

As indicated above, FIG. 4 is provided as an example. Other examples may differ from what is described with regard to FIG. 4.

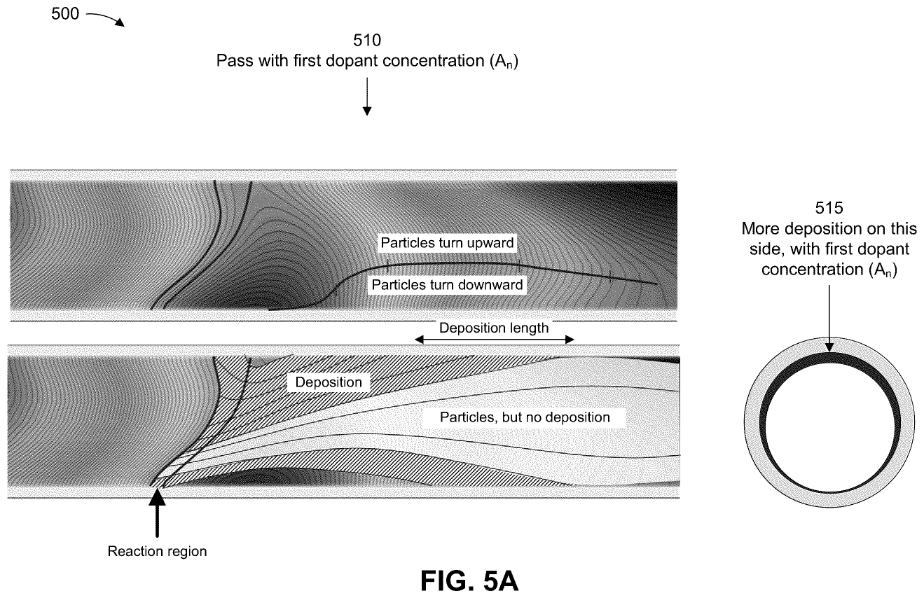

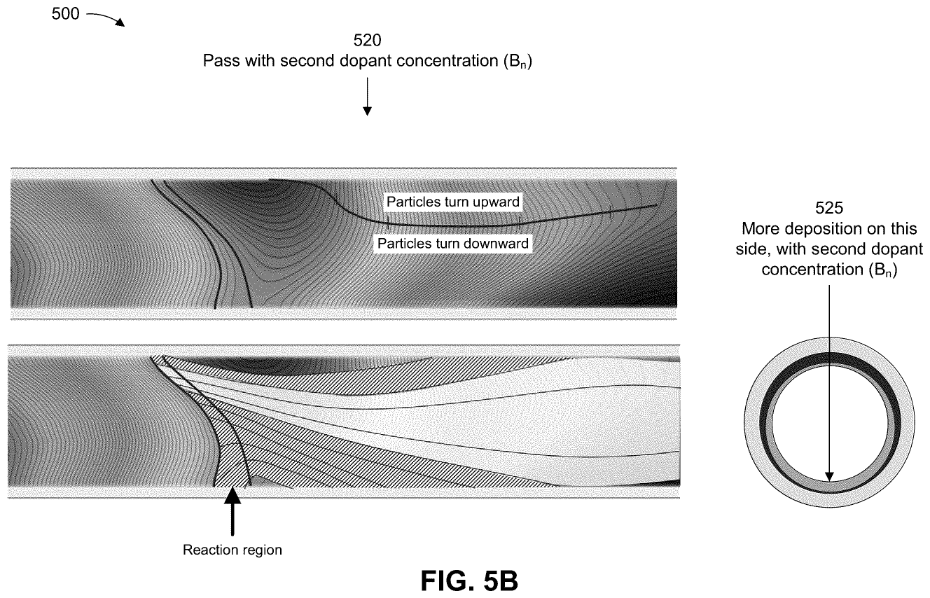

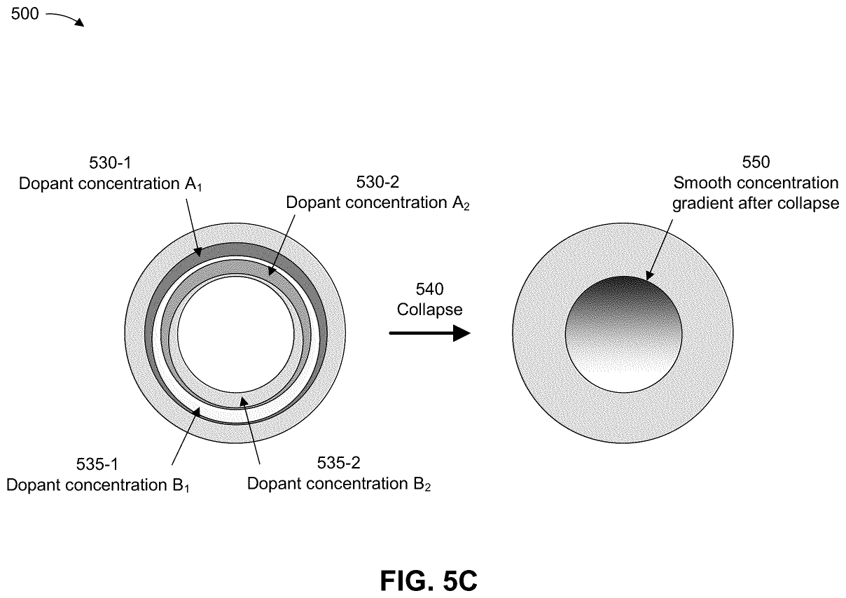

FIGS. 5A-5C illustrate an example implementation 500 of controlling a refractive index profile during preform manufacturing by adjusting a rotation of a substrate tube while dopants are delivered into the substrate tube (e.g., through an injection tube or using a rotary seal) to create a non-uniform temperature gradient that causes non-uniform layer deposition. For example, as described herein, example implementation 500 may manipulate the thermophoresis phenomenon to create temperature gradients within a substrate tube in a manner that may cause non-uniform layer deposition on the inner wall of the substrate tube, which may result in an azimuthally non-uniform doping concentration that provides a fiber preform with an azimuthally non-uniform refractive index profile.

For example, referring to FIG. 5A, reference number 510 depicts a first pass that may be performed with a first dopant concentration to create a non-symmetrical temperature profile within a substrate tube. In particular, as described herein, the heating source may move in a backward direction along a longitudinal axis of a substrate tube while the substrate tube is rotated and glass cursors are delivered into the substrate tube. While the heating source is moving in the backward direction, the heating source may generally heat the substrate tube to a temperature that is below a temperature at which glass softens. In some implementations, rotation of the substrate tube may then be suspended, or the substrate tube may be rotated at a quasi-sinusoidal speed (e.g., where a speed at which the substrate tube rotates is slowest at a first orientation of the substrate tube and highest at a second orientation of the substrate tube that is 180 degrees opposite of the first orientation). Accordingly, suspending the rotation of the substrate tube and/or rotating the substrate tube at the quasi-sinusoidal speed may create a temperature gradient from one side of the substrate tube to the other side of the substrate tube. For example, as shown in FIG. 5A, the temperature gradient may cause a first volume of particles that are formed in the reaction region to turn upward and be deposited on one side of the substrate tube and may cause a second volume particles to turn downward and be deposited on the opposite side of the substrate tube, where the first volume is larger than the second volume. Furthermore, the temperature gradient causes some particles to remain within the central portion of the substrate tube where no deposition occurs, and such particles may then be passed through to the exhaust. In this way, as shown by reference number 515, a non-uniform layer of porous doped material may be deposited on the inner wall of the substrate tube, where there is more deposition on one side of the substrate tube due to the temperature gradient that was created by adjusting the rotation of the substrate tube (e.g., suspending the rotation or rotating at a quasi-sinusoidal speed). Furthermore, in the first pass, a first dopant concentration, A₁, is used for the dopants delivered into the substrate tube. The porous deposited layer is then vitrified in the first pass when the heating source subsequently moves in a forward direction along the longitudinal axis of the substrate tube while the substrate tube rotates at a regular (e.g., constant) speed.

Referring now to FIG. 5B, reference number 520 depicts a second pass that may be performed with a second dopant concentration to create a non-symmetrical temperature profile within the substrate tube. In particular, in a similar manner as the first pass, the heating source may move in a backward direction along the longitudinal axis of the substrate tube while the substrate tube is rotated and glass cursors are delivered into the substrate tube. While the heating source moves in the backward direction, the heating source may heat the substrate tube to a temperature that is below a temperature at which glass softens. In some implementations, rotation of the substrate tube may then be suspended at an orientation that is turned 180 degrees relative to the orientation at which the rotation of the substrate tube was suspended in the first pass. Alternatively, in cases where the substrate tube is rotated at a quasi-sinusoidal speed in the first pass, the quasi-sinusoidal rotation speed of the substrate tube may be phase shifted 180 degrees in the second pass. In either case, backward deposition may then occur using a second dopant concentration, B₁. Accordingly, suspending the rotation of the substrate tube and/or rotating the substrate tube at the (phase shifted) quasi-sinusoidal speed may create a temperature gradient from one side of the substrate tube to the other side of the substrate tube, which is generally reversed from the temperature gradient that is created in the first pass. For example, as shown in FIG. 5B, the temperature gradient may cause a first volume of particles that are formed in the reaction region to turn upward and be deposited on one side of the substrate tube and may cause a second volume particles to turn downward and be deposited on the opposite side of the substrate tube, where the first volume is smaller than the second volume. Furthermore, as with the first pass, the temperature gradient causes some particles to remain within the central portion of the substrate tube where no deposition occurs, and such particles may then be passed through to the exhaust. In this way, as shown by reference number 525, a non-uniform layer of porous doped material may be deposited on the inner wall of the substrate tube, where there is more deposition on the other side of the substrate tube due to the temperature gradient that was created by adjusting the rotation of the substrate tube (e.g., turning the substrate tube 180 degrees relative to the first pass or rotating the substrate tube at a quasi-sinusoidal speed that is phase shifted 180 degrees relative to the first pass). The porous deposited layer is then vitrified in the second pass when the heating source subsequently moves in a forward direction along the longitudinal axis of the substrate tube while the substrate tube rotates at a regular (e.g., constant) speed.

Accordingly, as shown in FIG. 5C, several repetitions of the first pass and the second pass may be performed in alternation, generating alternating deposition layers on the inner wall of the substrate tube. For example, after performing a first iteration of the first pass and a first iteration of the second pass as described above, there may be a first non-uniform layer 530-1 associated with dopant concentration A₁ and a first non-uniform layer 535-1 associated with dopant concentration B₁. In the first iteration of the first and second pass, a difference between the dopant concentration A₁ and the dopant concentration B₁ may have an initial (maximum) value. In each subsequent pass, the difference between the dopant concentration Aᵢ and the dopant concentration Bᵢ may decrease, where i represents the number of the current iteration. For example, as shown in FIG. 5C, a second non-uniform layer 530-2 associated with dopant concentration A₂ may be formed in a second iteration of the first pass, and a second non-uniform layer 530-2 associated with dopant concentration A₂ may be formed in a second iteration of the second pass, where a difference between dopant concentration A₂ and dopant concentration B₂ is less than a difference between dopant concentration A₁ and dopant concentration B₁. In this way, by generating alternating non-uniform deposition layers and decreasing the dopant concentration difference between Aᵢ and Bᵢ in each subsequent pair of passes, a smooth gradient is created toward the center of the substrate tube. As shown by reference number 540, the substrate tube is then collapsed, which causes the various non-uniform deposition layers associated with the different dopant concentrations to partially diffuse into each other, creating a smooth concentration gradient (or non-uniform refractive index profile) across from one side of the collapsed preform structure to the opposite side of the collapsed preform structure.

As indicated above, FIGS. 5A-5C are provided as an example. Other examples may differ from what is described with regard to FIGS. 5A-5C.

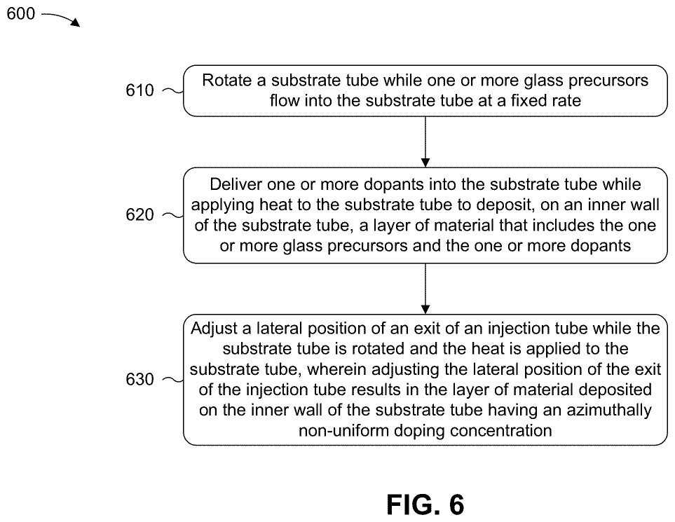

FIG. 6 is a flowchart of an example process 600 associated with controlling a refractive index profile during preform manufacturing by adjusting a lateral position of an injection tube. In some implementations, one or more process blocks of FIG. 6 are performed by a preform manufacturing system (e.g., the preform manufacturing system shown in FIG. 2).

As shown in FIG. 6, process 600 may include rotating a substrate tube while one or more glass precursors flow into the substrate tube at a fixed rate (block 610). For example, the preform manufacturing system may rotate a substrate tube while one or more glass precursors flow into the substrate tube at a fixed rate, as described above.

As further shown in FIG. 6, process 600 may include delivering one or more dopants into the substrate tube while applying heat to the substrate tube to deposit, on an inner wall of the substrate tube, a layer of material that includes the one or more glass precursors and the one or more dopants (block 620). For example, the preform manufacturing system may deliver one or more dopants into the substrate tube while applying heat to the substrate tube to deposit, on an inner wall of the substrate tube, a layer of material that includes the one or more glass precursors and the one or more dopants, as described above.

As further shown in FIG. 6, process 600 may include adjusting a lateral position of an exit of an injection tube while the substrate tube is rotated and the heat is applied to the substrate tube, wherein adjusting the lateral position of the exit of the injection tube results in the layer of material deposited on the inner wall of the substrate tube having an azimuthally non-uniform doping concentration (block 630). For example, the preform manufacturing system may adjust a lateral position of an exit of an injection tube while the substrate tube is rotated and the heat is applied to the substrate tube, as described above. In some implementations, adjusting the lateral position of the exit of the injection tube results in the layer of material deposited on the inner wall of the substrate tube having an azimuthally non-uniform doping concentration.

Process 600 may include additional implementations, such as any single implementation or any combination of implementations described below and/or in connection with one or more other processes described elsewhere herein.

In a first implementation, the lateral position of the exit of the injection tube is adjusted in a manner that is synchronized with rotating of the substrate tube.

In a second implementation, alone or in combination with the first implementation, adjusting the lateral position of the exit of the injection tube includes controlling one or more of an amplitude or a phase associated with a path of the injection tube while the substrate tube is rotated and a heat source that applies the heat to the substrate tube moves along a longitudinal axis of the substrate tube.

In a third implementation, alone or in combination with one or more of the first and second implementations, process 600 includes reshaping the substrate tube and the layer of material deposited on the inner wall of the substrate tube to form a preform structure, and drawing the preform structure to form a fiber core with a non-uniform refractive index profile that is based on the azimuthally non-uniform doping concentration of the layer of material deposited on the inner wall of the substrate tube.

In a fourth implementation, alone or in combination with one or more of the first through third implementations, the non-uniform refractive index profile is a slanted refractive index profile, having a maximum value at a first circumferential or azimuthal position of the fiber core, that monotonically decreases to a minimum value at a second circumferential or azimuthal position of the fiber core.

In a fifth implementation, alone or in combination with one or more of the first through fourth implementations, the non-uniform refractive index profile includes two or more azimuthal minima and maxima at opposing circumferential or azimuthal positions of the fiber core.

In a sixth implementation, alone or in combination with one or more of the first through fifth implementations, the non-uniform refractive index profile is a spiral refractive index profile having one or more maxima that rotationally vary along a length of the fiber core.

In a seventh implementation, alone or in combination with one or more of the first through sixth implementations, the non-uniform refractive index profile rotationally varies at different circumferential or azimuthal positions of the fiber core.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

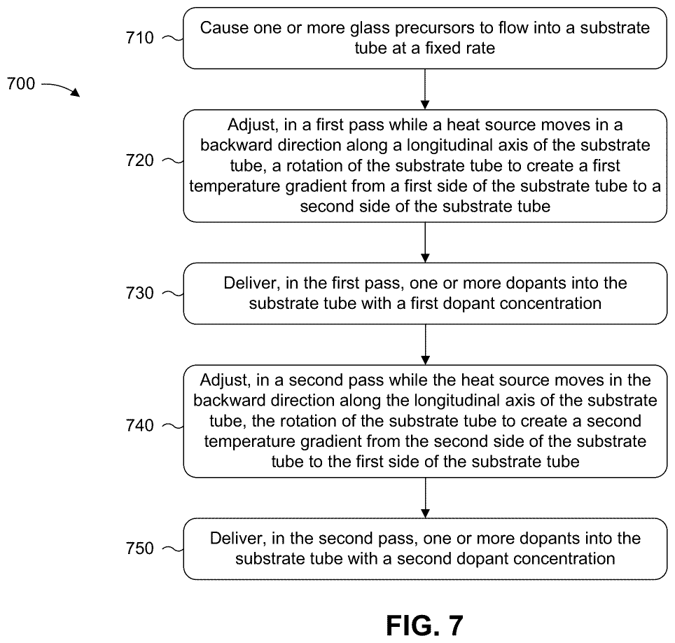

FIG. 7 is a flowchart of an example process 700 associated with controlling a refractive index profile for a fiber preform. In some implementations, one or more process blocks of FIG. 7 are performed by a preform manufacturing system (e.g., the preform manufacturing system shown in FIG. 2).

As shown in FIG. 7, process 700 may include causing one or more glass precursors to flow into a substrate tube at a fixed rate (block 710). For example, the preform manufacturing system may cause one or more glass precursors to flow into a substrate tube at a fixed rate, as described above.

As further shown in FIG. 7, process 700 may include adjusting, in a first pass while a heat source moves in a backward direction along a longitudinal axis of the substrate tube, a rotation of the substrate tube to create a first temperature gradient from a first side of the substrate tube to a second side of the substrate tube (block 720). For example, the preform manufacturing system may adjust, in a first pass while a heat source moves in a backward direction along a longitudinal axis of the substrate tube, a rotation of the substrate tube to create a first temperature gradient from a first side of the substrate tube to a second side of the substrate tube, as described above.

As further shown in FIG. 7, process 700 may include delivering, in the first pass, one or more dopants into the substrate tube with a first dopant concentration, wherein the first temperature gradient causes a first porous layer of material that includes the one or more glass precursors and the one or more dopants to be deposited on an inner wall of the substrate tube with a higher deposition volume on the first side of the substrate tube in the first pass (block 730). For example, the preform manufacturing system may deliver, in the first pass, one or more dopants into the substrate tube with a first dopant concentration, wherein the first temperature gradient causes a first porous layer of material that includes the one or more glass precursors and the one or more dopants to be deposited on an inner wall of the substrate tube with a higher deposition volume on the first side of the substrate tube in the first pass, as described above. In some implementations, the first temperature gradient causes a first porous layer of material that includes the one or more glass precursors and the one or more dopants to be deposited on an inner wall of the substrate tube with a higher deposition volume on the first side of the substrate tube in the first pass.

As further shown in FIG. 7, process 700 may include adjusting, in a second pass while the heat source moves in the backward direction along the longitudinal axis of the substrate tube, the rotation of the substrate tube to create a second temperature gradient from the second side of the substrate tube to the first side of the substrate tube (block 740). For example, the preform manufacturing system may adjust, in a second pass while the heat source moves in the backward direction along the longitudinal axis of the substrate tube, the rotation of the substrate tube to create a second temperature gradient from the second side of the substrate tube to the first side of the substrate tube, as described above.

As further shown in FIG. 7, process 700 may include delivering, in the second pass, one or more dopants into the substrate tube with a second dopant concentration, wherein the second temperature gradient causes a second porous layer of material that includes the one or more glass precursors and the one or more dopants to be deposited on the inner wall of the substrate tube with a higher deposition volume on the second side of the substrate tube in the second pass (block 750). For example, the preform manufacturing system may deliver, in the second pass, one or more dopants into the substrate tube with a second dopant concentration, wherein the second temperature gradient causes a second porous layer of material that includes the one or more glass precursors and the one or more dopants to be deposited on the inner wall of the substrate tube with a higher deposition volume on the second side of the substrate tube in the second pass, as described above. In some implementations, the second temperature gradient causes a second porous layer of material that includes the one or more glass precursors and the one or more dopants to be deposited on the inner wall of the substrate tube with a higher deposition volume on the second side of the substrate tube in the second pass.

Process 700 may include additional implementations, such as any single implementation or any combination of implementations described below and/or in connection with one or more other processes described elsewhere herein.

In a first implementation, process 700 includes adjusting the rotation of the substrate tube in the first pass includes suspending rotation of the substrate tube in a first orientation, and adjusting the rotation of the substrate tube in the second pass includes rotating the substrate tube to a second orientation that is rotated 180 degrees relative to the first orientation.

In a second implementation, alone or in combination with the first implementation, process 700 includes adjusting the rotation of the substrate tube in the first pass includes rotating the substrate tube at a first quasi-sinusoidal speed that is slowest when the substrate tube has a first orientation and fastest when the substrate tube has a second orientation that is opposite from the first orientation, and adjusting the rotation of the substrate tube in the second pass includes rotating the substrate tube at a second quasi-sinusoidal speed that is phase shifted 180 degrees relative to the first quasi-sinusoidal speed.

In a third implementation, alone or in combination with one or more of the first and second implementations, process 700 includes rotating, in the first pass while the heat source moves in a forward direction along the longitudinal axis of the substrate tube, the substrate tube at a constant rate to vitrify the first porous layer of material deposited on the inner wall of the substrate tube, and rotating, in the second pass while the heat source moves in the forward direction along the longitudinal axis of the substrate tube, the substrate tube at the constant rate to vitrify the second porous layer of material deposited on the inner wall of the substrate tube.

In a fourth implementation, alone or in combination with one or more of the first through third implementations, multiple repetitions of the first pass and multiple repetitions of the second pass are performed in alternation.

In a fifth implementation, alone or in combination with one or more of the first through fourth implementations, a difference between the first dopant concentration and the second dopant concentration decreases over the multiple repetitions of the first pass and multiple repetitions of the second pass to create a smooth gradient toward a center of the substrate tube.

In a sixth implementation, alone or in combination with one or more of the first through fifth implementations, process 700 includes reshaping the substrate tube to form a preform structure, and drawing the preform structure to form a fiber core with a non-uniform refractive index profile.

In a seventh implementation, alone or in combination with one or more of the first through sixth implementations, process 700 includes performing one or more repetitions of the first pass and the second pass, wherein a different between the first dopant concentration and the second dopant concentration decreases in each successive repetition of the first pass and the second pass.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A method for controlling a refractive index profile for a fiber preform, comprising:
rotating a substrate tube while one or more glass precursors flow into the substrate tube at a fixed rate;
delivering one or more dopants into the substrate tube while applying heat to the substrate tube to deposit, on an inner wall of the substrate tube, a layer of material that includes the one or more glass precursors and the one or more dopants; and
adjusting a lateral position of an exit of an injection tube while the substrate tube is rotated and the heat is applied to the substrate tube,
wherein adjusting the lateral position of the exit of the injection tube results in the layer of material deposited on the inner wall of the substrate tube having an azimuthally non-uniform doping concentration.

2. The method of claim 1, wherein the lateral position of the exit of the injection tube is adjusted in a manner that is synchronized with rotating of the substrate tube.

3. The method of claim 1, wherein adjusting the lateral position of the exit of the injection tube includes controlling one or more of an amplitude or a phase associated with a path of the injection tube while the substrate tube is rotated and a heat source that applies the heat to the substrate tube moves along a longitudinal axis of the substrate tube.

4. The method of claim 1, further comprising:
reshaping the substrate tube and the layer of material deposited on the inner wall of the substrate tube to form a preform structure; and
drawing the preform structure to form a fiber core with a non-uniform refractive index profile that is based on the azimuthally non-uniform doping concentration of the layer of material deposited on the inner wall of the substrate tube.

5. The method of claim 4, wherein the non-uniform refractive index profile is a slanted refractive index profile, having a maximum value at a first circumferential or azimuthal position of the fiber core, that monotonically decreases to a minimum value at a second circumferential or azimuthal position of the fiber core.

6. The method of claim 4, wherein the non-uniform refractive index profile includes two or more azimuthal minima and maxima at opposing circumferential or azimuthal positions of the fiber core.

7. The method of claim 4, wherein the non-uniform refractive index profile is a spiral refractive index profile having one or more maxima that rotationally vary along a length of the fiber core.

8. The method of claim 4, wherein the non-uniform refractive index profile rotationally varies at different circumferential or azimuthal positions of the fiber core.

9. A method for controlling a refractive index profile for a fiber preform, comprising:
causing one or more glass precursors to flow into a substrate tube at a fixed rate;
adjusting, in a first pass while a heat source moves in a backward direction along a longitudinal axis of the substrate tube, a rotation of the substrate tube to create a first temperature gradient from a first side of the substrate tube to a second side of the substrate tube;
delivering, in the first pass, one or more dopants into the substrate tube with a first dopant concentration,
wherein the first temperature gradient causes a first porous layer of material that includes the one or more glass precursors and the one or more dopants to be deposited on an inner wall of the substrate tube with a higher deposition volume on the first side of the substrate tube in the first pass;
adjusting, in a second pass while the heat source moves in the backward direction along the longitudinal axis of the substrate tube, the rotation of the substrate tube to create a second temperature gradient from the second side of the substrate tube to the first side of the substrate tube; and
delivering, in the second pass, one or more dopants into the substrate tube with a second dopant concentration,
wherein the second temperature gradient causes a second porous layer of material that includes the one or more glass precursors and the one or more dopants to be deposited on the inner wall of the substrate tube with a higher deposition volume on the second side of the substrate tube in the second pass.

10. The method of claim 9, wherein:
adjusting the rotation of the substrate tube in the first pass includes suspending rotation of the substrate tube in a first orientation, and
adjusting the rotation of the substrate tube in the second pass includes rotating the substrate tube to a second orientation that is rotated 180 degrees relative to the first orientation.

11. The method of claim 9, wherein:
adjusting the rotation of the substrate tube in the first pass includes rotating the substrate tube at a first quasi-sinusoidal speed that is slowest when the substrate tube has a first orientation and fastest when the substrate tube has a second orientation that is opposite from the first orientation, and
adjusting the rotation of the substrate tube in the second pass includes rotating the substrate tube at a second quasi-sinusoidal speed that is phase shifted 180 degrees relative to the first quasi-sinusoidal speed.

12. The method of claim 9, further comprising:
rotating, in the first pass while the heat source moves in a forward direction along the longitudinal axis of the substrate tube, the substrate tube at a constant rate to vitrify the first porous layer of material deposited on the inner wall of the substrate tube; and
rotating, in the second pass while the heat source moves in the forward direction along the longitudinal axis of the substrate tube, the substrate tube at the constant rate to vitrify the second porous layer of material deposited on the inner wall of the substrate tube.

13. The method of claim 9, wherein multiple repetitions of the first pass and multiple repetitions of the second pass are performed in alternation.

14. The method of claim 13, wherein a difference between the first dopant concentration and the second dopant concentration decreases over the multiple repetitions of the first pass and multiple repetitions of the second pass to create a smooth gradient toward a center of the substrate tube.

15. The method of claim 9, further comprising:
reshaping the substrate tube to form a preform structure; and
drawing the preform structure to form a fiber core with a non-uniform refractive index profile.

16. The method of claim 9, further comprising:
performing one or more repetitions of the first pass and the second pass,
wherein a different between the first dopant concentration and the second dopant concentration decreases in each successive repetition of the first pass and the second pass.

17. An optical fiber, comprising:
a core having a rotationally varying refractive index profile; and
a cladding surrounding the core.

18. The optical fiber of claim 17, wherein the core has a circular shape and an azimuthally varying dopant concentration with one or more concentration minima and one or more concentration maxima around a circumference of the core.

19. The optical fiber of claim 17, wherein a cross-section of the core has a non-uniform doping concentration that causes the core to have the rotationally varying refractive index profile.

20. The optical fiber of claim 17, wherein the rotationally varying refractive index profile includes a cross-section with a slanted refractive index profile, having a maximum value at a first circumferential or azimuthal position of the core, that monotonically decreases to a minimum value at a second circumferential or azimuthal position of the core.

21. The optical fiber of claim 17, wherein the rotationally varying refractive index profile includes two or more azimuthal minima and maxima at opposing circumferential or azimuthal positions of the core.

22. The optical fiber of claim 17, wherein the rotationally varying refractive index profile is a spiral refractive index profile having one or more maxima that rotationally vary along a length of the core.
